(19) United States
(12) Patent Application Publication
(10) Pub. No.: US 2010/0242359 A1
(43) Pub. Date: Sep. 30, 2010

(54) HANGING PLANTER FOR GROWING UPSIDE DOWN PLANTS FROM SEEDS

(76) Inventor: William James Rance, JR., Plainfield, NJ (US)

Correspondence Address: Eli Weiss, Esq.;Oakwood Law Group, LLP, 14 Bond Street -- SUITE 386, Great Neck, NY, 11021, US

(21) Appl. No.: 12/732,170

(22) Filed: Mar. 25, 2010

Related U.S. Application Data
(60) Provisional application No. 61/163,069, filed on Mar. 25, 2009.

(51) Int. Cl. A01G 9/02

(52) U.S. Cl. 47/65.7; 47/67; 47/66.7

(57) ABSTRACT

A hanging planter for germinating seeds to seedlings and growing the seedlings to full size plants where the planter has an opening in its bottom and a retainer plug located within the planter to prevent a layer of soil in the bottom of the planter from falling out when the planter is turned upside down. With the planter upside down, a seed is passed through the opening to the soil in the bottom of the planter and is watered thru the opening in the planter bottom as it grows right side up. While the plant is a seedling the planter is turned from its upside down position to its right side up position and hung above the ground to turn the stalk portion of the seedling from being right side up to being upside side down while the root portion remains located in the planter without having been replanted.

### REFERENCE TO RELATED APPLICATIONS

This patent application claims the benefit of U.S. Provisional Application No. 61/163,069 filed on Mar. 25, 2009, the disclosure of which is incorporated herein in its entirety by reference.

### BACKGROUND OF THE INVENTION

1. Field of the Invention

The present invention relates to home gardening and, more specifically, to a hanging planter for growing vegetables, herbs, etc. upside down after the seeds germinated into upright seedlings in the hanging planter without having been transplanted.

2. Description of Related Art

Cultivating plants such as vegetables and herbs upside down in a hanging planter is known in the prior art. More specifically, by way of example U.S. Pat. No. 7,171,782 to Felknor, et al. relates to a planter for growing a transplantable plant in a container. The sidewalls of the container have at least one grow port which provides access to the interior of the container, and the planter further includes a plant insertion sleeve having two side sections which are hingedly connected to one another so that when the sleeve is positioned in its opened condition, the root system of a plant to be transplanted is located within one of the side sections of the sleeve, and the side sections can be subsequently moved to a closed condition about the root system to place the plant insertion sleeve and root system in condition for insertion into a grow port of the container for continued growth of the plant in soil contained within the container.

U.S. Pat. No. 7,140,149 to Searle, et al. relates to a portable planter for high-density growth of plants. The planter contains a bottom and at least one wall disposed on the bottom for forming a cavity. The wall contains a plurality of holes which allow plant stems to extend therethrough in a generally horizontal orientation. At least one drain hole is formed in the bottom for draining water from the cavity. Plant growth medium is placed in the cavity, and plants are planted in the plant growth medium such that the stems extend through the holes in the wall.

U.S. Pat. No. 6,874,278 to Felknor, et al. relates to a container having an interior, a bottom and a hole in the bottom and further utilizes a retainer member which is attached to the plant that to be transplanted within the planter. The retainer member together with the container supports the plant through the hole in the container bottom so that the root system is exposed to the interior of the container and the plant stem extends downwardly from the bottom of the container.

U.S. Pat. No. 6,345,466 to Venanzi relates to a portable gardening system having an assembled center support, large base, small base and grow box with a plurality of holes in the bottom for growing multiple types of vegetation upside down out of the bottom of the grow box. In addition, plants and vegetation can be grown upright, as well, out of the open top of the grow box.

U.S. Pat. No. 6,298,600 to Feldman relates to a suspended planting container having an aperture which defines a central vegetation region. An outer wall extends upward from the periphery of the base to a top edge and defines a container region. An inner wall, surrounding the central vegetation region extends upward from the base to a top edge in the interior of the container region. A growing medium retention device is coupled to the top edge of the inner wall to permit vegetation to grow through a perforation into the central vegetation region but prevent growing medium from falling from the container region into the vegetation region.

U.S. Pat. No. 6,094,861 to Sandman, et al. relates to growing tomatoes and other vegetables out from the bottom of a container suspended above ground. A drip well in the top of the container provides a constant source of moisture.

U.S. Pat. No. 5,404,672 to Sanderson relates to a modular column planter having a lower, middle and upper container. Each container has a bottom connecting with a sidewall that extends upwardly to define a top opening. On the lower container bottom is a post having a slotted, top retaining cup. Positioned about an opening in a bottom of the middle and upper container is an upright, hollow column and a lower column extension. The planter is formed by fitting respectively the bottom of the middle and upper container in the top opening of the middle and upper container. As located, the middle container column extension fits into the lower container retaining cup and the upper container column extension fits into the middle container column upper end. These now joined columns form a watering tube. Soil in the lower and middle containers is moistened by filling the watering tube which then discharges to plants growing outward through openings in the sidewalls of these containers.

U.S. Pat. No. 5,333,409 to Mendes relates to a hanging planter having a plurality of tubular inserts which extend through the outer wall of the planter. The root portion of the growing plants are planted within the planter and the stalks of growing plants are extended through the tubular inserts so that they hang downwardly from the planter. The tubular inserts surround the stalks or stems of the plants and protect them from breaking under their own weight as they hang down.

### SUMMARY OF THE INVENTION

In an exemplary embodiment of the present invention, there is disclosed a hanging planter for germinating seeds to seedlings and growing the seedlings to full size plants comprising:
a planter having at least one opening in the bottom of the planter;
a handle attached to the planter to hang the planter on a support member above the ground; and
a retainer plug adapted to be located within the planter to prevent a layer of soil in the bottom of the planter from falling out when the planter is turned upside down;
wherein the planter is placed upside down and at least one seed is passed through the opening and into the soil in the bottom of the planter and is watered thru the opening in the bottom of the planter as it grows right side up with its root portion located in the planter and its stalk portion extending upright from the bottom of the upside down planter and, while the plant is a seedling and with the single motion, turning the planter from its upside down position to its right side up position and hanging it on a hook by its handle, the stalk portion of the seedlings are turned from being right side up to being upside side down while the root portion remains located in the planter and the stalk portion continues growing while hanging downwardly from the planter without having been replanted.

In another embodiment of the present invention, there is disclosed a method for germinating seeds to seedlings and growing the seedlings to full size plants in a planter comprises:
providing a planter having at least one opening in the bottom of the planter;
attaching a handle to the planter to hang the planter on a support member above the ground; and
locating a retainer plug within the planter to prevent a layer of soil in the bottom of the planter from falling out when the planter is turned upside down;
wherein the planter is placed upside down and at least one seed is passed through the opening and into the soil in the bottom of the planter and is watered thru the opening in the bottom of the planter as it grows right side up with its root portion located in the planter and its stalk portion extending upright from the bottom of the upside down planter and, while the plant is a seedling and with the single motion, turning the planter from its upside down position to its right side up position and hanging it on a hook by its handle, the stalk portion of the seedlings are turned from being right side up to being upside side down while the root portion remains located in the planter and the stalk portion continues growing while hanging downwardly from the planter without having been replanted.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a side view of components for starting at least one plant from a seed while the plant is right side up in an upside down planter and, while the plant is a seedling, turning the planter right side up to turn the seedling upside down to grow the seedling to a mature plant while it is upside down in the right side up planter in one step without replanting in accordance with the principles of the invention

FIG. 2 is a top perspective view of the components of the invention shown in FIG. 1;

FIG. 3 is a bottom perspective view of the planter shown in FIG. 1;

FIG. 4 is a side view of a plant growing from a seed out thru the bottom of an upside down planter in accordance with the principles of the invention;

FIG. 5 is a side view of the planter of FIG. 4 which, with the single simple motion of turning the planter from upside down to right side up and hanging it on a hook by a handle, the seedling is turned from right side up to upside side down to continue growing without being replanted in accordance with the principles of the invention;

FIG. 6 is bottom perspective view of an embodiment of the invention where the bottom of the planter has two openings for starting two separate seedlings right side up from seeds in a planter that is upside down and then, with the single simple motion of turning the planter from upside down to right side up and hanging it on a hook by a handle, the seedlings are turned from right side up to upside side down to continue growing without being replanted in accordance with the principles of the invention;

FIG. 7 is bottom perspective view of an embodiment of the invention where the bottom of the planter has three openings for starting three separate seedlings right side up from seeds in a planter that is upside down and then, with the single simple motion of turning the planter from upside down to right side up and hanging it on a hook by a handle, the seedlings are turned from right side up to upside side down to continue growing without being replanted in accordance with the principles of the invention;

FIG. 8 is bottom perspective view of an embodiment of the invention where the bottom of the planter has four openings for starting four separate seedlings right side up from seeds in a planter that is upside down and then, with the single simple motion of turning the planter from upside down to right side up and hanging it on a hook by a handle, the seedlings are turned from right side up to upside side down to continue growing without being replanted in accordance with the principles of the invention; and

FIG. 9 is bottom perspective view of an embodiment of the invention where the bottom of the planter has five openings for starting five separate seedlings right side up from seeds in a planter that is upside down and then, with the single simple motion of turning the planter from upside down to right side up and hanging it on a hook by a handle, the seedlings are turned from right side up to upside side down to continue growing without being replanted in accordance with the principles of the invention.

### DESCRIPTION OF THE PREFERRED EMBODIMENT

Growing a garden can be an arduous task, especially for senior citizens or those who are unable to leave their home. The process requires a lot of kneeling, bending, and digging. For those who have bad backs, bad knees, or overall poor mobility, planting, cultivating, weeding, fertilizing, and watering vegetables can be difficult and possibly painful. For many it is difficult to set the stakes in the ground and tie up the vines, which are both necessary steps in maintaining an outdoor vegetable garden. It is also not possible to grow a healthy garden without a proper amount of land. Many people live in apartments and do not have access to a yard. With such limited space, it is difficult to plant the garden desired.

The invention disclosed allows individuals who are homebound or who have limited land for gardening to grow plants and vegetables year round with minimum effort and expense. All that is required is a planter with at least one opening in the bottom, a few seeds and soil, all of which takes up very little space inside a home. The process can be use by almost everyone. There is no hard labor involved in planting the seeds and, therefore, it can be used by the elderly and those with injuries such as back sprains. The one step process here disclosed does not disturb the roots of a plant which allows it to continue to grow undisturbed.

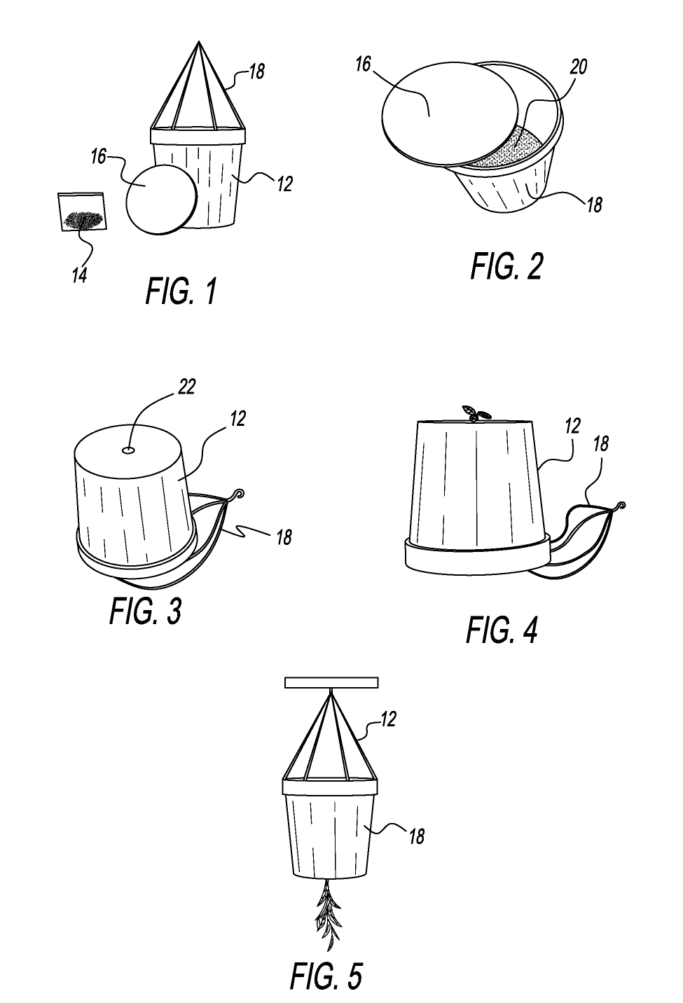

Referring to FIG. 1, there is shown a side view of the components for starting at least one plant from a seed where the seedling is right side up in an upside down planter and, while the plant is a seedling, turning the planter right side up to both turn the seedling upside down and grow the seedling to a mature plant while it is upside down in the right side up planter in one step without replanting the seedling. Included in the components are a planter 12, a packet of seeds 14, soil (not shown) located in the bottom of the planter 12, and a retainer plug 16 which is placed on top of the soil to keep it in place when the planter is being shipped and/or is upside down.

A handle having a hook or a loop, or three braided ropes or wires 18 are attached to the planter to provide a means to hang the planter from a hook or bar that is located above the ground. The handle may be either fixed or removably attached to the planter. The handle should be made of any sturdy material with sufficient strength to hold the combined weight of the planter, soil and plant.

The seed can be in a separate container such as a sealed envelope that may be made of paper or plastic that can be recycled. By keeping the seeds separate from the soil, they will not germinate until a user elects to start the process.

In this embodiment the planter has a single opening in its bottom which can be centrally located or displaced from the center.

The retainer plug 16 can be a round disc of plastic such as expanded polystyrene foam or any other material that can be used to keep the soil in place in the bottom of a round planter while the planter is being sent to a user and/or the planter is upside down while a seed is growing into a seedling.

Referring to FIG. 2, there is shown a top perspective view of the retainer plug 16 located on top of the planter 12 having soil 20 located in the bottom of the planter. If desired, a small piece of degradable paper can be placed over the opening in the bottom of the planter to prevent soil from falling out thru the opening in the bottom of the planter during shipping. The paper can be either on the inside or the outside of the planter. If the paper is placed on the inside of the planter, the user can pierce the paper with the sharp point of a pencil immediately prior to planting a seed.

Referring to FIG. 3, there is shown a bottom perspective view of the planter 12. Located at the center of the bottom is circular opening 22 which extends thru to the inside of the planter. This is the opening that at least one seed is placed into when the planter is first being used. It is also the opening which is used to water the seed and the growing seeding while the seedling is right side up and the planter is upside down.

The bottom of the planter can have a slight concave shape or depression to direct water that is poured onto the bottom surface to the opening to water the seedling without spilling over the edge of the planter and dripping on the floor.

Referring to FIG. 4, there is shown a side view of a seedling growing from a seed out thru the opening 22 in the bottom of the planter 16 while the planter is upside down. Thus, during the early stages of seed germination the planter, while being upside down is the seeding tray for starting the seeds growing. The planter remains upside down until the seedling has grown to a height of between 2 inches to 3 inches more or less, at which time the planter is turned right side up and hung above the floor on a hook or a bar.

Referring to FIG. 5, there is shown a side view of the planter having been turned right side up and hung above the floor and the seedling has been automatically turned upside down when the planter was turned right side up. Thus, with the single simple motion of turning the planter from upside down to right side up and hanging it above the floor on a hook by its handle, the seedling turned from right side up to upside side down to continue growing without having been replanted, and the planter which was a seedling tray now is a pot for the plants to grow in. As time goes by the seedling continue to grow out of the bottom of the hanging planter and matures into a full size hanging plant.

When the planter is turned right side up and hung above the floor, the plant is watered by pouring water directly into the planter.

In an embodiment of the invention the disc of expanded polystyrene foam is made with a plurality of small passageways which allow water to pass thru to the soil.

In another embodiment the expanded polystyrene foam functions as a barrier to the passage of water. With this embodiment, when the planter is turned right side up the user can either remove the expanded polystyrene foam disc from the planter or he/she can leave the disc in the planter and puncture the expanded polystyrene foam disc by pushing the sharp end of a pencil thru it in at least one place to allow water to wet the soil.

The planters can be available in a variety of different materials, sizes and colors to accommodate the preferences of a user. For example the planters may be made of terra cotta (clay), ceramic, plastic or metal. The planters can be color coded to remind a user what plant is growing in which planter.

A variety of seeds are available for a user to choose from. These may include but are not limited to cucumbers, tomatoes, eggplant, zucchini, different variety of peppers, different flowers, herbs, etc.

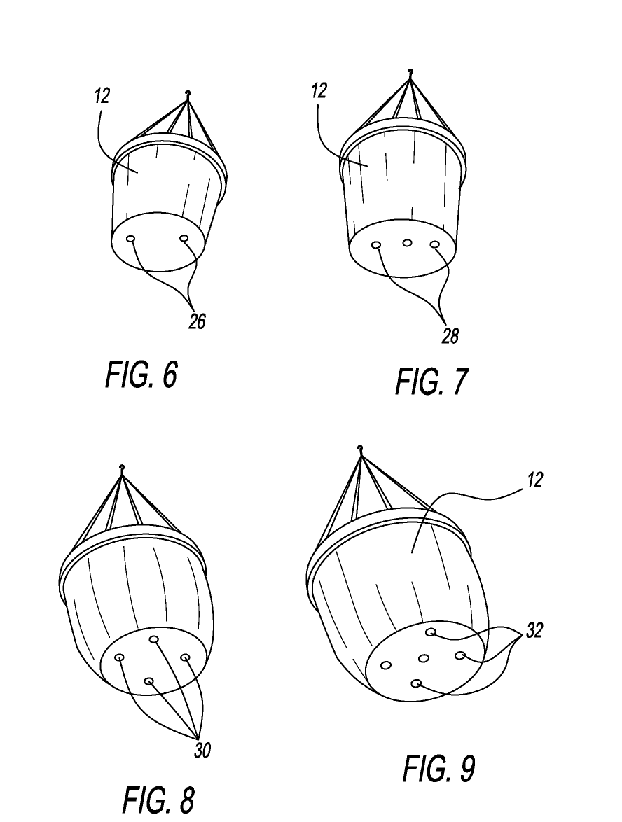

In an embodiment of the invention the planter can have two separate openings for growing plants. Referring to FIG. 6, there is shown a bottom perspective view of the invention where the bottom of the planter has two openings 26 for starting two separate seedlings right side up from seeds while the planter is upside down and then, with the single simple motion of turning the planter from upside down to right side up and hanging it on a hook by a handle, the seedlings are turned from right side up to upside side down to continue growing without having been replanted.

In an embodiment of the invention the planter can have three separate openings for growing plants. Referring to FIG. 7, there is shown a bottom perspective view of the invention where the bottom of the planter has three openings 28 for starting three separate seedlings right side up from seeds while the planter is upside down and then, with the single simple motion of turning the planter from upside down to right side up and hanging it on a hook by a handle, the seedlings are turned from right side up to upside side down to continue growing without having been replanted.

In an embodiment of the invention the planter can have four separate openings for growing plants. Referring to FIG. 8, there is shown a bottom perspective view of the invention where the bottom of the planter has four openings 30 for starting four separate seedlings right side up from seeds while the planter is upside down and then, with the single simple motion of turning the planter from upside down to right side up and hanging it on a hook by a handle, the seedlings are turned from right side up to upside side down to continue growing without having been replanted.

In an embodiment of the invention the planter can have five separate openings for growing plants. Referring to FIG. 9, there is shown a bottom perspective view of the invention where the bottom of the planter has five openings 32 for starting five separate seedlings right side up from seeds while the planter is upside down and then, with the single simple motion of turning the planter from upside down to right side up and hanging it on a hook by a handle, the seedlings are turned from right side up to upside side down to continue growing without having been replanted.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A hanging planter for germinating seeds to seedlings and growing the seedlings to full size plants comprising:
a planter having at least one opening in the bottom of the planter;
a handle attached to the planter to hang the planter on a support member above the ground; and
a retainer plug adapted to be located within the planter to prevent a layer of soil in the bottom of the planter from falling out when the planter is turned upside down;
wherein the planter is placed upside down and at least one seed is passed through the opening and into the soil in the bottom of the planter and is watered thru the opening in the bottom of the planter as it grows right side up with its root portion located in the planter and its stalk portion extending upright from the bottom of the upside down planter and, while the plant is a seedling and with the single motion, turning the planter from its upside down position to its right side up position and hanging it on a hook by its handle, the stalk portion of the seedlings are turned from being right side up to being upside side down while the root portion remains located in the planter and the stalk portion continues growing while hanging downwardly from the planter without having been replanted.

2. The hanging planter for germinating seeds to seedlings and growing the seedlings to full size plants of claim 1 wherein the retainer plug is composed of a plastic.

3. The hanging planter for germinating seeds to seedlings and growing the seedlings to full size plants of claim 2 wherein the planter is round and the retainer plug is a disc.

4. The hanging planter for germinating seeds to seedlings and growing the seedlings to full size plants of claim 3 wherein the disc is expanded polystyrene foam.

5. The hanging planter for germinating seeds to seedlings and growing the seedlings to full size plants of claim 3 wherein water can pass thru the disc.

6. The hanging planter for germinating seeds to seedlings and growing the seedlings to full size plants of claim 2 wherein the planter is made of clay, ceramic, plastic or metal.

7. The hanging planter for germinating seeds to seedlings and growing the seedlings to full size plants of claim 1 wherein the bottom of the planter is concave.

8. The hanging planter for germinating seeds to seedlings and growing the seedlings to full size plants of claim 1 wherein the bottom of the planter has between one and five openings.

9. A method for germinating seeds to seedlings and growing the seedlings to full size plants in a planter comprises:
providing a planter having at least one opening in the bottom of the planter;
attaching a handle to the planter to hang the planter on a support member above the ground; and
locating a retainer plug within the planter to prevent a layer of soil in the bottom of the planter from falling out when the planter is turned upside down;
wherein the planter is placed upside down and at least one seed is passed through the opening and into the soil in the bottom of the planter and is watered thru the opening in the bottom of the planter as it grows right side up with its root portion located in the planter and its stalk portion extending upright from the bottom of the upside down planter and, while the plant is a seedling and with the single motion, turning the planter from its upside down position to its right side up position and hanging it on a hook by its handle, the stalk portion of the seedlings are turned from being right side up to being upside side down while the root portion remains located in the planter and the stalk portion continues growing while hanging downwardly from the planter without having been replanted.

10. The method of claim 9 wherein the retainer plug is composed of a plastic.

11. The method of claim 10 wherein the planter is round and the retainer plug is a disc.

12. The method of claim 11 wherein the disc is expanded polystyrene foam.

13. The method of claim 11 wherein water can pass thru the disc.

14. The method of claim 10 wherein the planter is made of clay, ceramic, plastic or metal.

15. The method of claim 9 wherein the bottom of the planter is concave.

16. The method of claim 9 wherein the bottom of the planter has between one and five openings.

17. A system for germinating seeds to seedlings and growing the seedlings to full size plants in a hanging planter comprising:
a planter having at least one opening in the bottom of the planter;
a handle attached to the planter to hang the planter on a support member above the ground; and
a retainer plug adapted to be located within the planter to prevent a layer of soil in the bottom of the planter from falling out when the planter is turned upside down;
wherein the planter is placed upside down and at least one seed is passed through the opening and into the soil in the bottom of the planter and is watered thru the opening in the bottom of the planter as it grows right side up with its root portion located in the planter and its stalk portion extending upright from the bottom of the upside down planter and, while the plant is a seedling and with the single motion, turning the planter from its upside down position to its right side up position and hanging it on a hook by its handle, the stalk portion of the seedlings are turned from being right side up to being upside side down while the root portion remains located in the planter and the stalk portion continues growing while hanging downwardly from the planter without having been replanted.

18. The system for germinating seeds to seedlings and growing the seedlings to full size plants in a hanging planter of claim 17 wherein the retainer plug is composed of a plastic.

19. The system for germinating seeds to seedlings and growing the seedlings to full size plants in a hanging planter of claim 19 wherein the planter is round and the retainer plug is a disc.

20. The system for germinating seeds to seedlings and growing the seedlings to full size plants in a hanging planter of claim 19 wherein the disc is expanded polystyrene foam.
